(19) United States
(12) Patent Application Publication
(10) Pub. No.: US 2016/0146705 A1
(43) Pub. Date: May 26, 2016

(54) STATE HOLDING AND AUTONOMOUS INDUSTRIAL SENSING DEVICE

(71) Applicant: GENERAL ELECTRIC COMPANY, Schenectady, NY (US)

(72) Inventor: Ertugrul Berkcan, Niskayuna, NY (US)

(21) Appl. No.: 14/552,197

(22) Filed: Nov. 24, 2014

(51) Int. Cl. G01M 15/14; G01M 15/02

(52) U.S. Cl. CPC G01M 15/14; G01M 15/02

(57) ABSTRACT

A passive sensor is configured to detect one or more operational parameters of a gas turbine. The passive sensor is coupled to the gas turbine. The passive sensor is also configured to extract a portion of energy from the one or more operational parameters to utilize for operation, store an indication of a value of the one or more operational parameters, transition from a first mechanical state to a second mechanical state according to the value of the one or more operational parameters, and to provide a signal in response to receiving an interrogation signal. The signal comprises the indication of the value of the one or more operational parameters.

### BACKGROUND

The subject matter disclosed herein relates to sensing devices, and more specifically, to systems and methods for providing state holding and autonomous sensing devices.

Certain rotating or fixed machines such as generators, turbines, electric motors, and the like may generally include a number of sensors to measure various parameters of the machines during operation. The sensors measuring the operational conditions of such machines may be subject to harsh conditions (e.g., high temperatures, high pressures, etc.) and may be instrumental to the optimal operation of such machinery. The sensors may thus require continuous power and warrant frequent maintenance and retrofitting. Moreover, while some operational parameters corresponding to the routine or normal operating conditions of these machines may be subject to continuous monitoring, certain other parameters may warrant less frequent or even sporadic monitoring. It may be thus useful to provide sensors equipped for prolonged usage.

### BRIEF DESCRIPTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In a first embodiment, a passive sensor is configured to detect one or more operational parameters of a gas turbine. The passive sensor is coupled to the gas turbine. The passive sensor is also configured to extract a portion of energy from the one or more operational parameters to utilize for operation, store an indication of a value of the one or more operational parameters, transition from a first mechanical state to a second mechanical state according to the value of the one or more operational parameters, and to provide a signal in response to receiving an interrogation signal. The signal comprises the indication of the value of the one or more operational parameters.

In a second embodiment, a system includes a a turbine system and one or more state-holding sensors coupled to the turbine system and configured to sense a vibration, a strain, a temperature, or a pressure of the turbine system. The one or more state-holding sensors include a storage mechanism including a latching device configured to hold or change a mechanical state in response to energy derived from the sensed vibration, strain, temperature, or pressure. The mechanical state of the storage mechanism includes an indication of a value of the sensed vibration, strain, temperature, or pressure. The one or more state-holding sensors also include communication circuitry configured to wirelessly provide the indication of the value of the sensed vibration, strain, temperature, or pressure upon receipt of one or more interrogation signals.

In a third embodiment, a device includes a state-holding sensing device configured to detect one or more physical parameters of an external system, extract a portion of energy from the one or more physical parameters to be utilized for operation of the state-holding sensing device, store a non-volatile indication of a value of the one or more physical parameters, and to change from a first mechanical state to a second mechanical state according to the value of the one or more physical parameters. Upon detection of an interrogation signal, and if a switch of the state-holding device is in a first state, the state-holding sensing device is configured to receive a first quantity of energy of the interrogation signal, and to reflect the first quantity of energy of the interrogation signal. If the switch of the state-holding device is in a second state, the state-holding sensing device is configured to receive a second quantity of energy of the interrogation signal, and to reflect the second quantity of energy of the interrogation signal. Reflecting the second quantity energy of the interrogation signal includes providing the indication of the value of the one or more physical parameters to an external device. The state-holding sensing device is also configured to reset the state-holding sensing device to the first mechanical state based at least in part on the interrogation signal.

### DRAWINGS

These and other features, aspects, and advantages of the present invention will become better understood when the following detailed description is read with reference to the accompanying drawings in which like characters represent like parts throughout the drawings, wherein:

FIG. 1 is a block diagram of an embodiment of an industrial system including one or more state holding sensing devices, in accordance with the present embodiments;

FIG. 2 is a block diagram of an embodiment of the one or more state holding sensing devices included in the system of FIG. 1, in accordance with the present embodiments;

FIG. 3 is a diagram of an embodiment of a measurement detection and communication system included within the one or more state holding sensing devices, in accordance with the present embodiments; and

FIG. 4 is a flowchart illustrating an embodiment of a process useful in passively detecting and storing operational and/or environmental parameters using the one or more state holding sensing devices, in accordance with the present embodiments.

### DETAILED DESCRIPTION

One or more specific embodiments of the invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the invention, the articles “a,” “an,” “the,” and “said” are intended to mean that there are one or more of the elements. The terms “comprising,” “including,” and “having” are intended to be inclusive and mean that there may be additional elements other than the listed elements.

Present embodiments relate to a state holding and autonomous sensing device that may be used to passively detect and store operational and/or environmental parameters associated with, for example, industrial machinery, industrial processes, or various other applications requiring long-term and/or infrequent monitoring. In certain embodiments, the sensing device may include a detection and communication system and power extraction source. The power extraction source may be used to extract energy from a sensed measurand and convert the extracted energy into an electrical signal to power the sensing device. The detection and communication system may include electromagnetic circuitry (e.g., antenna and impedance matching network) and one or more microelectromechanical systems (MEMS) or nanoelectromechanical systems (NEMS) devices that may be used to passively detect and store non-volatile values of sensed operational and/or environmental parameters. In one embodiment, the values of the parameters obtained by the sensing device may be read by generating a radio frequency (RF) signal and detecting an amount of reflected (e.g., passively reflected) energy from the sensing device. Further, because the sensing device may be both passive and autonomous (e.g., self-operative), the sensing device may allow for long-term (e.g., over periods of days, months, years, and so forth) monitoring of certain operational and/or environmental parameters in harsh environments without the need of external power or frequent maintenance, repair, or retrofitting.

Indeed, although the present embodiments may be discussed primarily with respect to state holding and autonomous sensors for turbine systems and/or other industrial machinery, it should be appreciated that the techniques described herein may also be extended to sensors useful in any of various applications such as, for example, sensors for medical applications (e.g., noninvasive sensing, heart monitoring), security related sensors (e.g., surveillance, motion detection), sensors for manufacturing and distribution applications (e.g., products manufacturing and products tracking systems), oil and gas exploration related sensing devices (e.g., sensors useful in downhole and subsea environments), sensors for energy extraction applications (e.g., coal mines, tunnels, and so forth), sensors for aerospace applications, and the like. As used herein, “passive” may refer to a condition in which a device may become operable autonomously or by way of one or more environmental conditions such that the device is self-powered and/or self-activated. Similarly, “passive” may refer to an electronic circuit or device that does not contain a source of energy, or that includes one or more components (e.g., resistors, capacitors, inductors, and so forth) that consume, but do not produce energy (e.g., power) in the electronic circuit as would otherwise be the case with active devices such as transistors. Similarly, “passive” may refer to a component or a system that is capable to operate without an external power source. Similarly, “passive” may refer to a component or a system that is capable to operate without using any electronics that need an external power source. As used herein, a “mechanical state” may refer to a physical state in which a change thereto or therefrom involves the physical movement of one or more parts of one or more mechanisms of a device or machine from one steady state to another. Furthermore, the term “mechanical state” may encompass a rest state or a transitional state of a microelectromechanical system (MEMS), nanoelectromechanical system (NEMS), or other system, which may include one or more moving parts that move or are displaced in response to a mechanical, electrical, chemical, magnetic, or other physical perturbation.

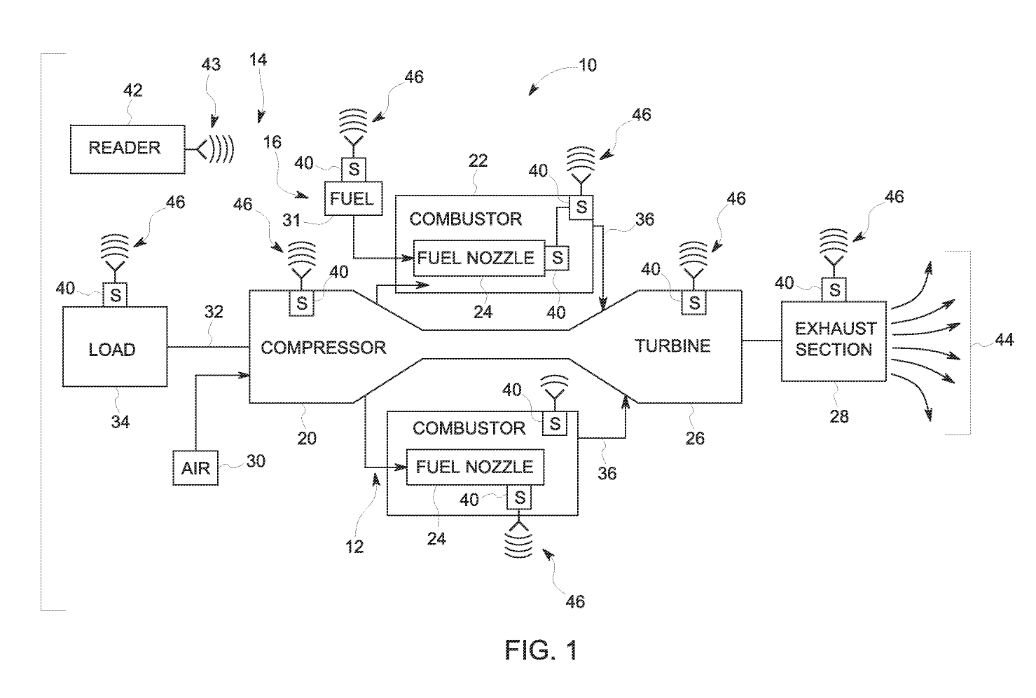

With the foregoing in mind, it may be useful to describe an embodiment of an industrial system, such as an example industrial system 10 illustrated in FIG. 1. Indeed, while the present embodiments may be discussed with respect to an illustration of a gas turbine system (e.g., as illustrated in FIG. 1), it should be appreciated that the industrial system 10 may, in some embodiments, include other types of rotary machinery, such as, but not limited to: a steam turbine system, a hydraulic turbine system, one or more compressor systems (e.g., aeroderivative compressors, reciprocating compressors, centrifugal compressors, axial compressors, screw compressors, and so forth), one or more electric motor systems, industrial systems including, for example, fans, extruders, blowers, centrifugal pumps, aircraft engines, wind turbines, combustors, transition pieces, portions or components of industrial machinery (e.g., rotating components, stationary components), or any of various other industrial machinery that may be included in an industrial plant or other industrial facility. As will be appreciated, to the extent such machinery includes components that rotate relative to a stationary structure, such rotational contexts are generally not suitable for hardwired connections between the rotating and stationary components. In addition, suitable machinery or systems, as discussed herein, may be placed in or may contain environments that are harsh and, therefore, unsuitable for placement of electronic equipment. For example, machinery or systems as discussed herein may include or define spaces or paths that constitute harsh environments (e.g., an internal, external, or intra-machine environment that experiences one or more of temperatures greater than or equal to 300° C., 500° C., 1200° C., or greater, pressures between approximately 1000 pounds per square inch (psi) and 18,000 psi, vibrations between approximately 5 mils and 20 mils, speeds between approximately 5,000 revolutions per minute (rpm) and 17,500 rpm, and so forth). Additionally, as noted above, the techniques discussed herein may be used in any of various applications apart from industrial applications.

As illustrated in FIG. 1, the industrial system 10 may include a gas turbine system 12, a monitoring system 14, and a fuel supply system 16. The gas turbine system 12 may include a compressor 20, combustion systems 22, fuel nozzles 24, a turbine 26, and an exhaust section 28. During operation, the gas turbine system 12 may pull air 30 into the compressor 20, which may then compress the air 30 and move the air 30 to the combustion system 22 (e.g., which may include a number of combustors). In the combustion system 22, the fuel nozzle 24 (or a number of fuel nozzles 24) may inject fuel that mixes with the compressed air 30 to create, for example, an air-fuel mixture.

The air-fuel mixture may combust in the combustion system 22 to generate hot combustion gases, which flow downstream into the turbine 26 to drive one or more turbine 26 stages. For example, the combustion gases move through the turbine 26 to drive one or more stages of turbine 26 blades, which may in turn drive rotation of a shaft 32. The shaft 32 may connect to a load 34, such as a generator that uses the torque of the shaft 32 to produce electricity. After passing through the turbine 26, the hot combustion gases may vent as exhaust gases 36 into the environment by way of the exhaust section 28. The exhaust gas 36 may include gases such as carbon dioxide (CO₂), carbon monoxide (CO), nitrogen oxides (NOₓ), and so forth.

In certain embodiments, the system 10 may also include a number of state-holding sensing devices 40 (e.g., sensors) and an interrogation device or reader 42. The interrogation device or reader 42 may receive data from the state-holding sensing devices 40 via an antenna 43 or other transceiver device. In certain embodiments, the state-holding sensing devices 40 may be any of various sensors useful in providing various operational data to the interrogation device or reader 42 including, for example, pressure and temperature of the compressor 20, speed and temperature of the turbine 26, vibration of the compressor 20 and the turbine 26, CO₂ levels in the exhaust gas 36, carbon content in the fuel 31, temperature of the fuel 31, temperature, pressure, clearance of the compressor 20 and the turbine 26 (e.g., distance between the compressor 20 and the turbine 26 and/or between other stationary and/or rotating components that may be included within the industrial system 10), flame temperature or intensity, vibration, combustion dynamics (e.g., fluctuations in pressure, flame intensity, and so forth), load data from load 34, and so forth. It should be appreciated that the aforementioned parameters are included merely for the purpose of example. In other embodiments, the state holding sensing device 40 may be useful in measuring any of various measurands including, but not limited to: temperature, pressure, flow rate, fluid level, displacement, acceleration, speed, torque, clearance, strain, stress, vibration, voltage, current, humidity, electromagnetic radiation, mass, magnetic flux, creep, crack, heat spots (e.g., hot spots), equipment condition, metal temperature, system health, and so forth. Furthermore, the state-holding sensing devices 40 may be useful in withstanding and operating within one or more harsh environments (e.g., an internal environment, external environment, or intra-machine environment that includes one or more of temperatures greater than or equal to 300° C., 500° C., 1200° C., or greater, pressures between approximately 1000 pounds per square inch (psi) and 18,000 psi, vibrations between approximately 5 mils and 20 mils, speeds between approximately 5,000 revolutions per minute (rpm) and 17,500 rpm, and so forth) in which active electronic devices may generally malfunction or become inoperable.

In certain embodiments, the reader 42 may be used to periodically (e.g., daily, monthly, annually, bi-annually, and so forth) or continuously (e.g., over minute intervals, hourly) obtain data from the state-holding sensing devices 40 as an indication of the operating condition of one or more components (e.g., the compressor 20, the turbine 26, the combustors 22, the load 34, and so forth) of the industrial system 10 and/or other environmental characteristics. The reader 42 may also be used to reset the state-holding sensing devices 40. Similar to the reader 42, the state-holding sensing devices 40 may also include an antenna 46 or other transceiver device for communicating with the reader 42. As will be further appreciated, the state-holding sensing devices 40 may include a passive (e.g., self-powered and including non-active electronic devices) device that may be useful in passively detecting and storing operational and/or environmental parameters associated with components of the industrial system 10 or other similar system or environment.

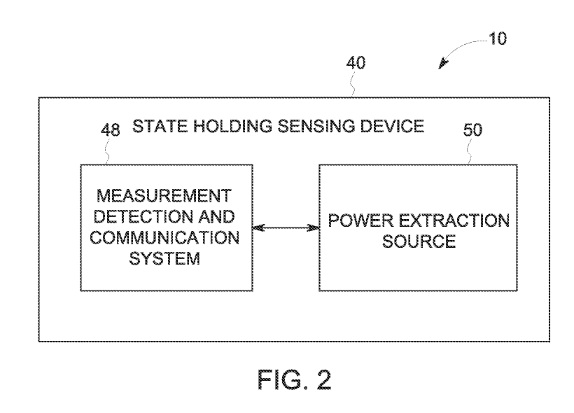

In certain embodiments, as illustrated in FIG. 2, the state-holding sensing devices 40 may include a measurement detection and communication system 48 and a power extraction source 50. As previously discussed, the state-holding sensing device 40 may include one or more passive (e.g., autonomously operable or quasi-autonomously operable) devices, such that the state-holding sensing device 40 may detect and store operational parameters without the use of an external source of power. Additionally, as the state-holding sensing device 40 may passively monitor certain operational and/or environmental parameters, the state-holding sensing device 40 may be useful in monitoring and storing these parameters over long periods of time (e.g., days, months, years, and so forth) without the need of an external power source or excessive human intervention through maintenance, repair, or retrofitting. In one or more embodiments, such monitoring may be performed without relying on a conventional power harvesting or energy harvesting device.

As further illustrated, the detection and communication system 48 may be communicatively coupled to the power extraction source 50. For example, during operation, as a measurand (e.g., operational and/or environmental parameter) is detected via the detection and communication system 48, the power extraction source 50 may extract energy from the measured operational and/or environmental parameter, and may temporarily store the extracted energy for use by, for example, the detection and communication system 48. In one embodiment, the detection and communication system 48 along with the power extraction source 50 may convert the measurand (e.g., temperature, pressure, flow rate, fluid level, displacement, acceleration, speed, torque, clearance, strain, stress, vibration, voltage, current, humidity, electromagnetic radiation, mass, magnetic flux, creep, crack, hot spots, equipment condition, metal temperature, system health, and so forth) to an electrical signal for power. In one embodiment, the power extraction source 50 may include a passive energy harvesting device (e.g., photovoltaic device, piezoelectric device, thermoelectric generator [TEG], or other similar energy harvesting device) that may be useful extracting energy from the measurands and/or one or more environmental sources. As will be further appreciated, the detection and communication system 48 may include electromagnetic circuitry (e.g., antenna and impedance matching network) and one or more microelectromechanical systems (MEMS) or nanoelectromechanical systems (NEMS) devices that may be useful in passively detecting and storing measurands (e.g., operational and/or environmental parameters) associated with the industrial system 10 or other similar system or environment. Specifically, one or more components of the detection and communication system 48 may change a physical state, which may include a chemical, electrical, or mechanical physical state, on the sensed measurands.

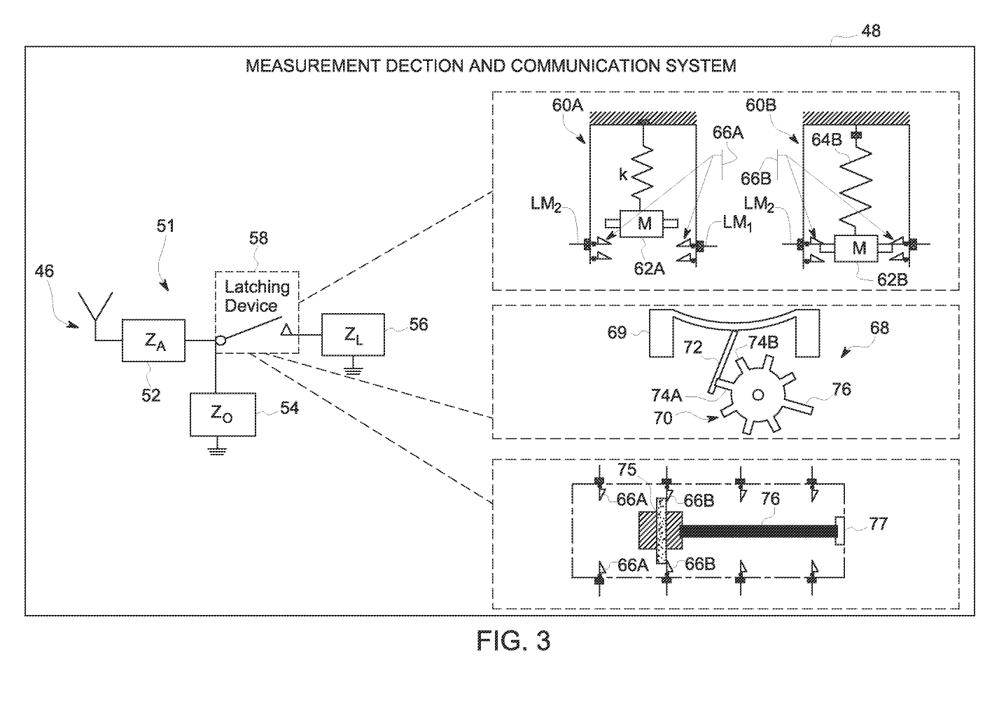

For example, as illustrated in FIG. 3, the detection and communication system 48 may include electromagnetic circuitry 51 (e.g., RF circuitry). As depicted, the electromagnetic circuitry 51 may include the antenna 46 and an impedance matching network, which may include a source impedance 52 (e.g., Z_{A}), a characteristic impedance 54 (e.g., Z₀), a load impedance 56 (e.g., Z_{L}), and a latching device 58. In certain embodiments, based on whether the latching device 58 is an open position or a closed position, the total impedance of the electromagnetic circuitry 51 may experience a change. The change in impedance may be indicative of a value of the sensed and/or detected measurand. Specifically, in certain embodiments, the characteristic impedance 54 (e.g., Z₀) may be set to predetermined value (e.g., approximately 50Ω). Similarly, the source impedance 52 (e.g., Z_{A}) may also be set to a predetermined value (e.g., approximately 50Ω or approximately 10-100Ω).

Thus, when an electromagnetic signal (e.g., RF interrogation signal) is detected at the antenna 46, and when the latching device is in the open position, complete transmittance of the energy of the electromagnetic signal may occur. However, the load impedance 56 (e.g., Z_{L}) may generally not be matched to the source impedance 52 (e.g., Z_{A}) and the characteristic impedance 54 (e.g., Z₀). Thus, in certain embodiments, when the latching device 58 is in the closed position, the load impedance (e.g., Z_{L}) 56 may be introduced into the electromagnetic circuitry 51. This may thus create a change in impedance in the electromagnetic circuitry 51. Further, because of the mismatch in impedance between, for example, the source impedance 52 (e.g., Z_{A}) and the characteristic impedance 54 (e.g., Z₀) and the load impedance 56 (e.g., Z_{L}) (e.g., corresponding to a condition in which Z_{A}∥Z₀≠Z_{L}*), strong reflectance of the electromagnetic energy detected at the antenna 46 may occur. Such a strong reflectance of the electromagnetic signal (e.g., RF interrogation signal) from the state-holding sensing device 40 back to, for example, the reader 42 may indicate the value of the sensed measurand. Furthermore, the electromagnetic signal (e.g., RF interrogation signal) generated by the reader 42 may be used to reset (e.g., reset or revert the physical state) the state-holding sensing device 40 to begin monitoring again or continue monitoring once the value of the sensed measurand has been obtained.

In certain embodiments, as further depicted in FIG. 3, the latching device may include one or more MEMS or NEMS devices. For example, in one embodiment, the latching device may include a mass-spring system 60 (e.g., 60A and 60B). Specifically, the mass-spring system 60A may represent the mass-spring system 60 at rest, or during a time in which a sensed measurand has not been stored. On the other hand, the mass-spring system 60B may represent the mass-spring system 60 when a sensed measurand has been detected and/or stored. As illustrated, the mass-spring system 60 may include a proof mass 62 (e.g., proof masses 62A and 62B), a spring 64 (e.g., 64A and 64B) including a k spring constant, and a number of multistable structures 66 (e.g., 66A and 66B). In one embodiment, the proof mass 62 may include any material (e.g., hard or soft material) that may be useful in exerting a force on the spring 64. In other embodiments, the proof mass 62 may include a soft or hard magnetic material for use when the mass-spring system 60 operates as, for example, a magnetic field or current sensor.

Referring to the mass-spring system 60B, based on a sensed measurand (e.g., temperature, pressure, flow rate, fluid level, displacement, acceleration, speed, torque, clearance, strain, stress, vibration, voltage, current, humidity, electromagnetic radiation, mass, magnetic flux, creep, crack, hot spots, equipment condition, metal temperature, system health, and so forth), a passive displacement of the proof mass 62B and the spring 64B may occur in response to the energy of the measurand. This may cause the proof mass 62B to latch to the multistable structures 66B (e.g., bi-stable structures). In another embodiment, the mass-spring system 60 may include a mass (e.g., proof mass 62), a spring (e.g., spring 64), and an additional damping element, and may be modeled, for example, as lumped-element model.

In certain embodiments, the displacement of the proof mass 62B, and, by extension, the latching of the proof mass 62B by the multistable structures 66B (e.g., bi-stable structures) may correspond to the storing of a value of a sensed measurand. For example, as further illustrated, the proof mass 62B becoming latched by the first couplet of multistable structures 66B may represent the storing of a first value of the measurand, while the latching of the proof mass 62B by the second illustrated couplet of multistable structures 66B may represent the storing of a second value of a sensed measurand. In other embodiments, the mass-spring system 60 (e.g., 60A and 60B) may include any number of couplets or sets (e.g., 3, 4, 5, 6, 7, 8, or more) of the multistable structures 66 (e.g., bi-stable structures 66A and 66B) to store any number of values of one or more sensed measurands. The latching of the proof mass 62B to any of the sets of multistable structures 66B may also correspond to the latching device 58 switching from the open position to the closed position. As previously discussed, the electromagnetic circuitry 51 may then form a closed circuit, and thus a change of the total impedance of the electromagnetic circuitry 51 may occur. The change in impedance may be indicative of the value of the sensed measurand. The value of the sensed measurand may be then obtained by the reader 42, for example, through a reflectance of an electromagnetic signal (e.g., RF interrogation signal) reflected by the state-holding sensing device 40. In this way, the state-holding sensing device 40 may passively detect and store measurands without the use of an external power source or excessive human intervention through maintenance, repair, or retrofitting.

In other embodiments, as further depicted in FIG. 3, the latching device 58 may include a cogwheel and coupling system 68. In some embodiments, the cogwheel and coupling system 68 may include a chemically coupling system, an electrically coupling system, or a mechanical coupling system. As illustrated, the cogwheel and coupling system 68 may include a diaphragm 69, a cogwheel 70 (e.g., toothed wheel or mechanical gear), and a lever device 72 coupled to the suspension device 69. In one embodiment, the cogwheel and coupling system 68 may be generally used to sense a pressure measurand. However, it should be appreciated that the cogwheel and coupling system 68 may also be used to sense and store any of various other operational parameters such as, for example, temperature, flow rate, fluid level, and so forth.

During operation, the cogwheel 70 may rotate in response to the detection and storage (e.g., non-volatile storage) of a sensed measurand. Specifically, as a force (e.g., pressure) is applied to the diaphragm 69, the lever 72 may cause the cogwheel 70 to rotate from, for example, the tooth 74A of the cogwheel 70 to, for example, the tooth 74B of the cogwheel 70. This change or change in state (e.g., rotation of the cogwheel 70) of the cogwheel and coupling system 68 (e.g., diaphragm system) may correspond to the storage (e.g., non-volatile storage) of a sensed measurand. In one embodiment, the cogwheel 70 may also include an extended tooth 76, which may, in some embodiments, include an electrode to transmit a voltage signal to close the latching device 58. As noted above, the electromagnetic circuitry 51 may then form a closed circuit, and thus a change of the total impedance of the electromagnetic circuitry 51 may occur. This change in impedance may be indicative of the value of the sensed measurand. The value of the sensed measurand may be then obtained by the reader 42, for example, through a reflectance of an electromagnetic signal (e.g., RF interrogation signal) reflected the state-holding sensing device 40. In another embodiment, the electromagnetic circuitry 51, and, by extension, the latching device 58 systems may also be useful in detecting or indicating a tampering of the state holding sensing device 40. For example, a foreign magnetic interference (e.g., an interference other than an authorized read signal provided by the reader 42) may cause the latching device 58 MEMS or NEMS systems to at least partially change physical states. This foreign magnetic interference may be determined when a subsequent read of the state holding sensing device 40 is performed.

Yet still, in another embodiment, as further depicted in FIG. 3, the latching device 58 may include a shorting bar and measurand responsive element system. In certain embodiments, the shorting bar and responsive element system may include a chemically responsive system, an electrically responsive system, or a mechanically responsive system. As illustrated, the shorting bar and responsive element system may include a shorting bar 75, a responsive element 76 (e.g., temperature responsive element) coupled to the shorting bar 75, and an anchor 77 coupled to the responsive element 76. During operation, the responsive element 76, which may include one or more bimetals, may extend or retract (e.g., change length) and/or expand or contract (e.g., change shape) in response to the detection and storage (e.g., non-volatile storage) of a sensed measurand. In one embodiment, the shorting bar and responsive element system may be generally used to sense a temperature measurand. However, it should be appreciated that the shorting bar and responsive element system may also be used to sense and store any of various other operational parameters such as, for example, pressure, strain, stress, vibration, and so forth.

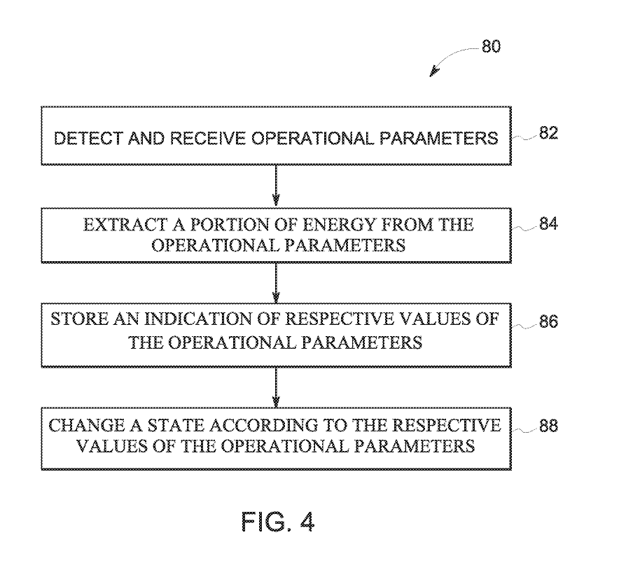

Turning now to FIG. 4, a flow diagram is presented, illustrating an embodiment of a process 80 useful in passively detecting and storing operational and/or environmental parameters, by using, for example, the state holding sensing device 40 depicted in FIG. 2. The process 80 may begin with the state holding sensing device 40 detecting (block 82) and receiving one or more operational parameters. As previously discussed, the state holding sensing device 40 may detect and/or receive temperature, pressure, flow rate, fluid level, displacement, acceleration, speed, torque, clearance, strain, stress, vibration, voltage, current, humidity, electromagnetic radiation, mass, magnetic flux, creep, crack, hot spots, equipment condition, metal temperature, system health, or various other operational and/or environmental parameters associated with, for example, the industrial system 10 or other similar system.

The process 80 may then continue with the state holding sensing device 40 generating (block 84) extracting a portion of energy from the one or more operational parameters. For example, the state holding sensing device 40 may include a power extraction source 50 that may be useful in extracting energy from the measured operational and/or environmental parameter, and may temporarily store the extracted energy for use by the state holding sensing device 40. The state holding sensing device 40 may then store (block 86) an indication of respective values of the operational parameters. For example, as noted above with respect to FIGS. 2 and 3, the state holding sensing device 40 may include electromagnetic circuitry 51 (e.g., antenna and impedance matching network) and one or more MEMS or NEMS devices that may be useful in passively detecting and storing operational and/or environmental parameters.

The process 80 may then conclude with the state holding sensing device 40 changing (block 88) a state according to the respective values of the operational parameters. For example, the state holding sensing device 40 may change a physical state (e.g., chemically, electrically, or mechanically) to provide an indication of one or more values of a sensed operational and/or environmental parameter by way of electromagnetic energy reflectance in response to an electromagnetic read signal (e.g., RF interrogation signal) transmitted to the state-holding sensing device 40. In this way, the state-holding sensing device 40 may passively detect and store measurands without the use of an external power source or excessive human intervention through maintenance, repair, or retrofitting.

Technical effects of the present invention relate to a state holding and autonomous sensing device that may be used to passively detect and store operational and/or environmental parameters associated with, for example, industrial machinery, industrial processes, or various other applications requiring long-term and/or infrequent monitoring. In certain embodiments, the sensing device may include a detection and communication system and power extraction source. The power extraction source may be used to extract energy from a sensed measurand and convert the extracted energy into an electrical signal to power the sensing device. The detection and communication system may include electromagnetic circuitry (e.g., antenna and impedance matching network) and one or more microelectromechanical systems (MEMS) or nanoelectromechanical systems (NEMS) devices that may be used to passively detect and store non-volatile values of sensed operational and/or environmental parameters. In one embodiment, the values of the parameters obtained by the sensing device may be read by generating a radio frequency (RF) signal and detecting an amount of reflected (e.g., passively reflected) energy from the sensing device. Further, because the sensing device may be both passive and autonomous (e.g., self-operative), the sensing device may allow for long-term (e.g., over periods of days, months, years, and so forth) monitoring of certain operational and/or environmental parameters in harsh environments without the need of external power or frequent maintenance, repair, or retrofitting.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A passive sensor, configured to:
detect one or more operational parameters of a gas turbine, wherein the electrically passive sensor is coupled to the gas turbine;
extract a portion of energy from the one or more operational parameters to utilize for operation;
store an indication of a value of the one or more operational parameters;
transition from a first mechanical state to a second mechanical state according to the value of the one or more operational parameters; and
provide a signal in response to receiving an interrogation signal, wherein the signal comprises the indication of the value of the one or more operational parameters.

2. The passive sensor of claim 1, wherein the passive sensor comprises a passive sensor configured to detect the one or more operational parameters over a period of time.

3. The passive sensor of claim 1, wherein the passive sensor is configured to wirelessly provide the signal in response to the interrogation signal.

4. The sensor of claim 1, wherein the passive sensor comprises a latching device comprising a microelectromechanical system (MEMS) or a nanoelectromechanical system (NEMS) configured to store the indication of the value of the one or more operational parameters by transitioning between a plurality of mechanical states.

5. The passive sensor of claim 4, wherein the latching device is configured to maintain the first mechanical state or the second mechanical state by utilizing one or more passive multistable structures.

6. The passive sensor of claim 4, wherein the latching device comprises a mass spring system and one or more multistable structures, and wherein storing the indication of the value of the one or more operational parameters comprises latching a mass of the mass spring system into a mechanical state of the one or more multistable structures.

7. The passive sensor of claim 4, wherein the latching device comprises a cogwheel and coupling system, and wherein the cogwheel is configured to rotate to store the indication of the value of the one or more operational parameters in response to an energy received by the cogwheel and coupling system from the one or more operational parameters.

8. The passive sensor of claim 1, comprising electromagnetic energy detection circuitry configured to change an impedance as the indication of the value of the one or more detected operational parameters.

9. The passive sensor of claim 1, wherein the passive sensor is configured to detect one or more operational parameters of a rotating machine, a synchronous machine, an asynchronous machine, a steam turbine, a hydraulic turbine, an aircraft engine, a wind turbine, a compressor, a combustor, a transition piece, a portion of a turbine, a rotating component, a stationary component, or any combination thereof.

10. The passive sensor of claim 1, wherein the one or more operational parameters comprises a temperature, a pressure, a flow rate, a fluid level, a displacement, an acceleration, a speed, a torque, a clearance, a strain, a stress, a vibration, a voltage, a current, a humidity, an electromagnetic radiation, a mass, a magnetic flux, a creep, a crack, a hot spot, an equipment condition, a metal temperature, a health of the external system, or any combination thereof.

11. A system, comprising:
a turbine system; and
one or more state-holding sensors coupled to the turbine system and configured to sense a vibration, a strain, a temperature, or a pressure of the turbine system, comprising:
a storage mechanism including a latching device configured to hold or change a mechanical state in response to energy derived from the sensed vibration, strain, temperature, or pressure, wherein the mechanical state of the storage mechanism comprises an indication of a value of the sensed vibration, strain, temperature, or pressure; and
communication circuitry configured to wirelessly provide the indication of the value of the sensed vibration, strain, temperature, or pressure upon receipt of one or more interrogation signals.

12. The system of claim 11, wherein the communication circuitry comprises electrically passive communication circuitry.

13. The system of claim 11, wherein the latching device is configured to reset the mechanical state in response to the interrogation signal.

14. The system of claim 11, wherein the storage mechanism is configured to hold or change to one of a plurality of mechanical states based on the sensed vibration, strain, temperature, or pressure, and wherein each of the plurality of mechanical states corresponds to a different value of the sensed vibration, strain, temperature, or pressure.

15. The system of claim 11, wherein the one or more state-holding sensors are configured to detect a tampering.

16. The system of claim 15, wherein the tampering comprises a magnetic interference.

17. A device, comprising:
a state-holding sensing device configured to:
detect one or more physical parameters of an external system;
extract a portion of energy from the one or more physical parameters to be utilized for operation of the state-holding sensing device;
store a non-volatile indication of a value of the one or more physical parameters;
change from a first mechanical state to a second mechanical state according to the value of the one or more physical parameters; and
upon detection of an interrogation signal:
if a switch of the state-holding device is in a first state:
receive the interrogation signal; and
reflect a first quantity of energy of the interrogation signal;
if the switch of the state-holding device is in a second state:
receive the interrogation signal;
reflect a second quantity of energy of the interrogation signal, wherein the second quantity differs from the first quantity and wherein the second quantity energy provides an indication of the value of the one or more physical parameters to an external device; and
reset the state-holding sensing device to the first mechanical state based at least in part on the interrogation signal.

18. The device of claim 17, wherein the state-holding sensing device is configured to wirelessly provide the indication of the value of the one or more physical parameters in response to the interrogation signal or unprovokedly.

19. The device of claim 18, wherein the state-holding sensing device is configured to wirelessly provide the indication of the value of the one or more physical parameters passively.

20. The device of claim 17, wherein the second quantity of energy is greater than the first quantity of energy.
